(19) United States
(12) Patent Application Publication
(10) Pub. No.: US 2008/0133102 A1
(43) Pub. Date: Jun. 5, 2008

(54) RUNNING CARRIAGE, METHOD OF CONTROLLING THE SAME, AND RUNNING CARRIAGE SYSTEM

(75) Inventor: Hideki KUBO, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA MACHINERY, LTD., Kyoto-shi (JP)

(21) Appl. No.: 11/949,500

(22) Filed: Dec. 3, 2007

(30) Foreign Application Priority Data
Dec. 1, 2006 (JP) 2006-325713

(51) Int. Cl. F02D 29/02

(52) U.S. Cl. 701/84

(57) ABSTRACT

A running distance is obtained from the number of rotation of running wheels of a running carriage by encoders, and an absolute position of the carriage is obtained by linear sensors. A difference between a change in an encoder value per a predetermined time and a change in a linear sensor value is obtained as slip, and a running motor is controlled through a running controller to eliminate the slip.

### BACKGROUND OF THE INVENTION

1. Field of the Invention

The present invention relates to a running carriage and a system thereof, and particularly to a system for detecting slip of wheels of the carriage and feeding back to a driving motor so as to reduce the slip.

2. Description of the Related Art

In a running carriage system, a velocity pattern of the running carriage is determined to enable the running carriage to run to a destination in a short time and to stop at the destination with high accuracy. However, if wheels of the running carriage slip, a delay in following the velocity pattern occurs to prolong the running time. Moreover, if the slip cannot be eliminated before the running carriage stops at the destination, the running time is further prolonged. Therefore, the velocity pattern is determined while allowing for delays so that the running carriage can stop at the destination even if the wheels slip, which increases a braking distance from deceleration to a stop and prolongs the running time. As described above, the slip causes the running carriage to deviate from the velocity pattern and prolongs the running time.

Japanese Unexamined Patent Publication No. 2004-287555 discloses comparing a dog position with a coordinate obtained from an encoder every time the running carriage detects a dog to thereby detect an amount of slip. In Japanese Unexamined Patent Publication No. 2004-287555, the running carriage stores a dog coordinate, a remaining running distance is corrected based on the detected amount of slip, and a velocity pattern is corrected. However, Japanese Unexamined Patent Publication No. 2004-287555 does not study feedback to a running motor so as to eliminate the slip. Even if Japanese Unexamined Patent Publication No. 2004-287555 aims to eliminate the slip, the amount of slip cannot be detected continuously with the dogs provided at intervals and therefore feedback control is difficult to be achieved.

### SUMMARY OF THE INVENTION

It is an object of the present invention to provide a running carriage capable of suppressing a delay from a target velocity pattern by carrying out feedback control of a driving motor so as to eliminate slip.

It is an additional object of the invention to enable the running carriage to quickly get out of idling and skidding states of wheels.

It is a further additional object of the invention to provide a running carriage system for swiftly and continuously detecting an absolute position of the running carriage with high accuracy and carrying out accurate feedback control so as to eliminate the slip of the running carriage.

According to the invention, there is provided a running carriage including: means for obtaining an amount of driving of driving wheels of the running carriage and a change per time in the amount of driving; means for obtaining an absolute position of the running carriage and a change per time in the absolute position; detecting means for comparing the change in the amount of driving and the change in the absolute position to obtain an amount of slip per time of the running carriage; and control means for controlling a driving motor of the driving wheels to eliminate the obtained amount of slip.

A method of controlling a running carriage according to the invention includes the steps of:

obtaining an amount of driving of driving wheels of the running carriage and a change per time in the amount of driving;

obtaining an absolute position of the running carriage and a change per time in the absolute position;

comparing the change in the amount of driving and the change in the absolute position to obtain an amount of slip per time of the running carriage; and

controlling a driving motor of the driving wheels to eliminate the obtained amount of slip.

It is preferable that the control means reduces a rotating speed of the driving motor when the change in the amount of driving is greater than the change in the absolute position by a value equal to or greater than a predetermined value, and increases the rotating speed of the driving motor when the change in the amount of driving is smaller than the change in the absolute position by a value equal to or greater than the predetermined value.

A running carriage system according to the invention includes marks provided in at least two lines while spaced from each other along a running route of the running carriage, the running carriage including: means for obtaining an amount of driving of driving wheels of the running carriage and a change per time in the amount of driving; at least two linear sensors for detecting the marks in at least two lines; means for obtaining an absolute position of the running carriage and a change per time in the absolute position from outputs of the at least two linear sensors; means for comparing the change in the amount of driving and the change in the absolute position to obtain an amount of slip per time of the running carriage; and control means for controlling a driving motor of the driving wheels to eliminate the obtained amount of slip.

The amount of driving in the invention is a distance over which the wheels such as the running wheels are driven, and the change per time in the amount of driving is a speed seen from internal sensors for monitoring rotation of the wheels or a moving distance per time.

In the specification, description regarding the running carriage holds true for the running carriage system as it is, and description regarding the running carriage system holds true for the running carriage as it is.

In the invention, the change per time in the amount of driving of the driving wheels and the change per time in the absolute position of the running carriage are compared with each other, and the amount of slip occurring per time is obtained. Then, the amount of slip is fed back to the driving motor to eliminate the amount of slip. Therefore, the slip of the running carriage is eliminated and the running carriage can run following the target velocity pattern. As a result, moving time can be shortened and the running carriage can accurately stop at the destination.

The slip includes idling and skid. It is preferable to reduce the rotating speed of the driving motor when the idling is detected from the fact that the change in the amount of driving is greater than the change in the absolute position, and to increase the rotating speed of the driving motor when the skid is detected from the fact that the change in the amount of driving is smaller than the change in the absolute position.

It is preferable that marks are provided in at least two lines while spaced from each other along the running route of the running carriage, and that at least two linear sensors detect the marks in at least two lines to obtain the absolute position of the running carriage and the change per time in the absolute position. In this manner, it is possible to accurately and swiftly obtain the absolute position of the running carriage and the change in the absolute position. Then, by comparing the obtained change with the change in the amount of driving of the driving wheels, it is possible to eliminate the slip by fast-response and accurate feedback control.

### BRIEF DESCRIPTION OF THE DRAWINGS

FIG. 1 is a block diagram of a running carriage system according to an embodiment;

FIG. 2 is a block diagram of a linear sensor used in the embodiment;

FIG. 3 is a view showing conversion from a linear sensor value into an absolute position in the embodiment;

FIG. 4 is a block diagram of a slip detector; and

FIG. 5 is a flow chart showing a slip control algorithm in the embodiment.

### DESCRIPTION OF THE NUMERALS

2 running carriage
4 running route
6,7 running motors
8,9 running wheels
10 driving shaft
11,12 encoders
13,14 linear sensors
15 slip detector
16,17 running controllers
20 alternating current source
21 coil
22,24 calculation circuits
41 processing unit
42 offset table
43 tracking table
L1˜L5, R1˜R5 magnetic marks

### DETAILED DESCRIPTION OF THE PREFERRED EMBODIMENT

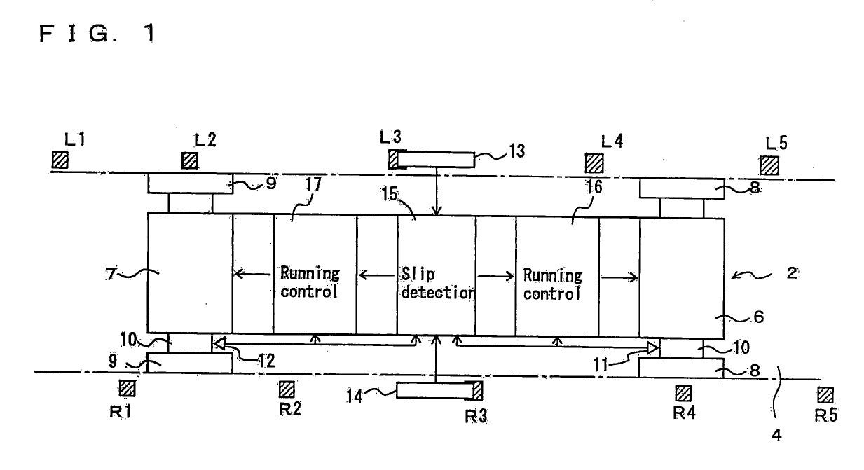

FIGS. 1 to 5 show a running carriage system according to an embodiment. In the drawings, a running carriage 2 may be a rail guided vehicle or a railless vehicle, and is a stacker crane, a rail guided carriage, an automated guided vehicle, an overhead traveling vehicle, or the like, for example. As the running carriage, there is also a vehicle that makes a motion other than horizontal running. A running velocity pattern generator (not shown) of the running carriage 2 generates a running velocity pattern from a start point to a destination, and the running carriage 2 runs according to the velocity pattern. The running carriage 2 orbits or reciprocates along a running route 4. For example, the running carriage 2 includes front and rear running motors 6, 7, for driving running wheels 8, 9, respectively. A driving shaft 10 connects the running motors 6, 7 and the running wheels 8, 9. Encoders 11, 12 are provided along the driving shaft 10 to detect an amount of rotation of the driving shaft 10, i.e., amounts of driving of the running wheels 8, 9. The amounts of driving in the embodiment are the total numbers of rotation of the running wheels 8, 9, and the like seen from internal sensors such as the encoders 11, 12.

Magnetic marks L1 to L5, R1 to R5 are provided in two lines, for example, on left and right opposite sides of the running route 4. The magnetic marks may be provided in three or more lines (e.g., four lines), and may be provided in two or more lines not on the left and right opposite sides but on one of the left and right sides of the running route 4. At least two linear sensors 13, 14 are provided to the running carriage 2, and the linear sensor 13 detects the magnetic marks L1 to L5 while the linear sensor 14 detects the magnetic marks R1 to R5. The actual number of magnetic marks is greater than ten shown in FIG. 1. The linear sensors 13, 14 output relative coordinates with respect to the magnetic marks L1 to L5, R1 to R5 and their detection areas overlap with each other. For example, in FIG. 1, the magnetic mark L3 is getting out of the detection area of the linear sensor 13 when the magnetic mark R3 enters the detection area of the linear sensor 14. The linear sensors 13, 14 of any kind may be employed as long as the sensors can continuously and linearly output the relative coordinates with respect to the marks. Although magnets are used as the magnetic marks L1 to L5, R1 to R5 in the embodiment, the marks may be other magnetic materials or non-magnetic marks.

The running carriage 2 includes a slip detector 15 for detecting respective amounts of slip of the front and rear running wheels 8, 9 by using signals (sensor values) of the linear sensors 13, 14 and signals (encoder values) of the encoders 11, 12. The slip detector 15 obtains changes in the encoder values per predetermined time, i.e., differentials and temporal differentials of the encoder values, and likewise obtains differentials and temporal differentials of the sensor values per time of the linear sensors 13, 14. Time intervals at which the differentials or the like are obtained may be fixed or variable. The slip detector 15 compares the differential and the temporal differential of the encoder value of the encoder 11 with a differential and a temporal differential of an absolute position of the running carriage 2 obtained from the linear sensors 13, 14 to detect an amount of slip occurring per the predetermined time in the running wheels 8 on the running motor 6 side. Similarly, the slip detector 15 compares the differential and the temporal differential of the encoder value per time of the encoder 12 with the differential and the temporal differential of the absolute position obtained from the linear sensors 13, 14 to detect an amount of slip per time of the running wheels 9.

The running carriage 2 includes the running velocity pattern generator for running from the start point to the destination. A running controller 16 controls the running motor 6 according to the running velocity pattern and corrects the running velocity pattern based on the amount of slip per time obtained by the slip detector 15. The running velocity pattern is determined so that the running carriage 2 can run to the destination in a short time with vibration thereof suppressed and can accurately stop at the destination. Similarly, a running controller 17 controls the running motor 7 according to the running velocity pattern and corrects the running velocity pattern based on the amount of slip of the running wheels 9 obtained by the slip detector 15. In other words, a control loop for eliminating the slip corresponds to a minor loop of control by the running velocity pattern. In feedback control by the amount of slip, the amount of slip having occurred per time is used. Besides, a kind of PID control may be carried out by adding an integration value of the amount of slip per time and a rate of change of the amount of slip per time as control inputs and using the amount of slip per time as a proportional P of the control inputs.

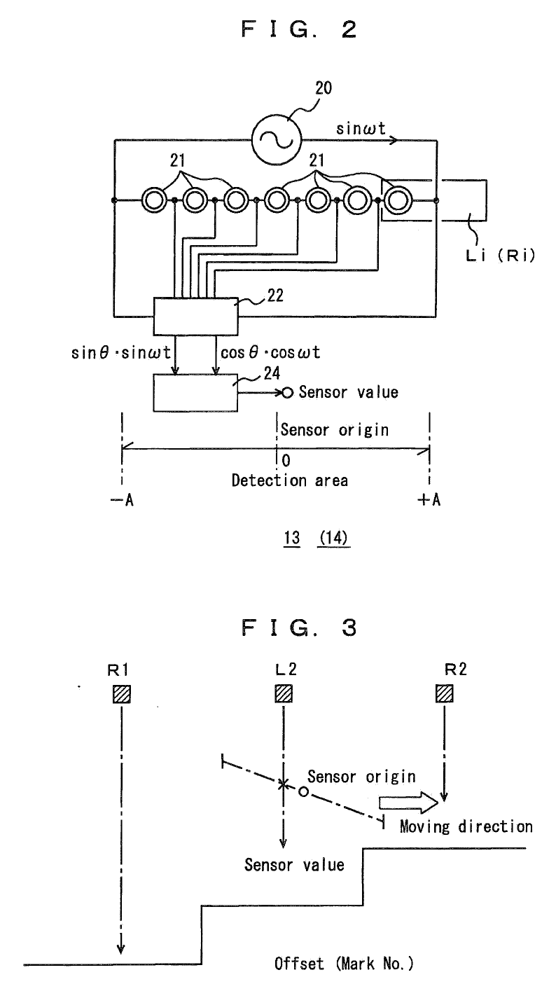

A configuration of the linear sensor 13 (14) is shown in FIG. 2. An alternating current source 20 has a phase of output current of sin ωt. A plurality of coils 21 are connected in series. Voltage applied to each coil is input to a calculation circuit 22 to obtain a relative position of a magnetic mark Li (Ri) with respect to a detection area (−A to +A) of the linear sensor 13. If a phase of the magnetic mark with respect to the detection area (width: 2A) is θ, the calculation circuit 22 outputs a signal such as sin θ·sin ωt and cos θ·cos ωt by utilizing the fact that inductance of each individual coil changes depending on the position of the magnetic mark. A calculation circuit 24 obtains the phase θ from the signal and outputs the position of the magnetic mark with respect to the detection area as the sensor value. A central portion of the detection area of the linear sensor 13 (14) is a sensor origin and a displacement from this position is the sensor value.

FIG. 3 shows detection of the absolute position of the running carriage by using the left and right magnetic marks. The slip detector recognizes which magnetic mark is currently detected, and stores an absolute position (absolute coordinate) of the sensor origin (a point at which the linear sensor value is zero) with respect to each magnetic mark as an offset. If the sensor value from the linear sensor is added to the absolute coordinate of the sensor origin, it is possible to know the absolute position of the running carriage. To perform this processing, it is necessary to recognize which magnetic mark is currently detected. For example, if the running carriage starts from a predetermined position, the number of a magnetic mark at the start time is known. Next, a running direction of the running carriage is known and therefore the number of a magnetic mark to be detected next is obtained and stored every time the magnetic mark to be detected is changed. Thus, it is possible to always recognize the number of the magnetic mark that is being detected.

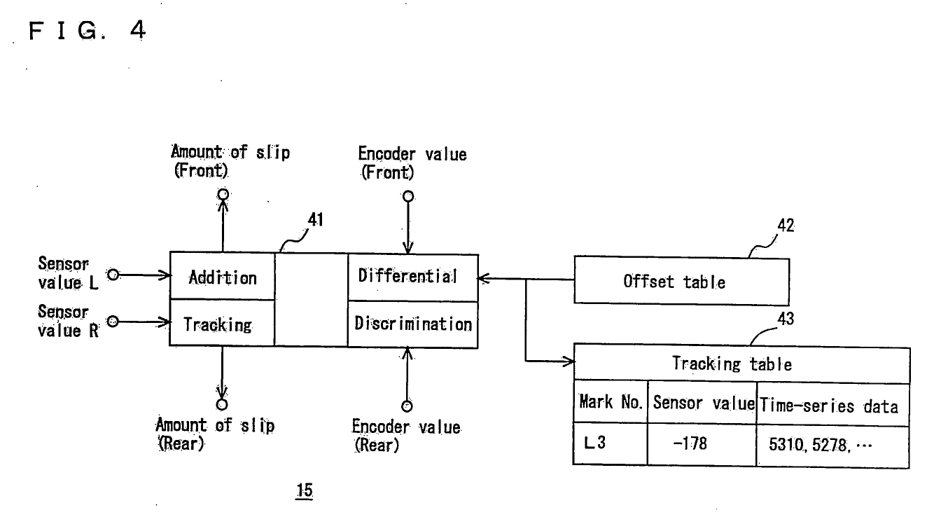

FIG. 4 shows a configuration of the slip detector 15 including a processing unit 41, an offset table 42, and a tracking table 43. The absolute coordinate of the sensor origin with respect to each magnetic mark is written in the offset table 42, and the linear sensor value is added thereto to thereby obtain the absolute coordinate. Every time the magnetic mark is changed, the number of the new magnetic mark is tracked. In the tracking table 43, the number of the magnetic mark that is currently detected, the sensor value related to the magnetic mark, and time-series data of the absolute coordinate determined based thereon are written. For the sake of ease, a differential between the encoder values is obtained simultaneously with update of the time-series data in the tracking table 43. The processing unit 41 detects the differential between the sensor values of the front and rear encoders 11, 12 and the differential between the previous absolute coordinate and the current absolute coordinate in the tracking table 43. Instead of the simple differential between the previous and current coordinates, it is also possible to use a weighed mean value of differentials of past several coordinates, for example. The processing unit 41 compares the differential between the encoder values and the differential between the absolute coordinates to detect the amounts of slip per time of the running wheels 8, 9.

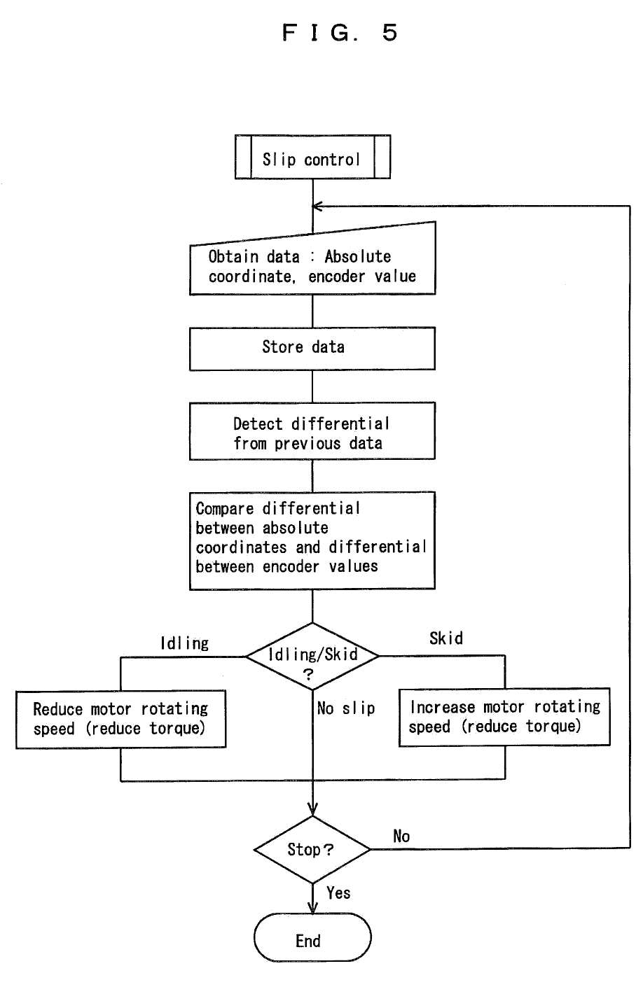

FIG. 5 shows an algorithm of slip control of the running carriage. The slip detector obtains the sensor values from the linear sensors to convert into the absolute coordinates and store the same. Moreover, the slip detector obtains the encoder values and stores the same. Differentials between current data and previous data of the absolute coordinate from the linear sensor and the encoder value are obtained. The differential between the encoder values and the differential between the absolute values are compared with each other to detect presence or absence of slip. For example, if a difference therebetween is equal to or lower than a predetermined value, it is determined that there is no slip. If the differential between the encoder values is greater than the differential between the absolute coordinates by a value equal to or greater than the predetermined value, it is determined that there is idling, and torque is reduced so as to reduce the rotating speed of the motor. If the differential between the absolute coordinates is greater than the differential between the encoder values by a value equal to or greater than the predetermined value, it is determined that the running wheels are skidding, the motor rotating speed is increased and torque is reduced. These items of processing are performed independently for the front and rear running wheels. The predetermined value used for detecting the presence or absence of the idling and skidding may be simply a fixed value or may be a value variable depending on speed, acceleration, or the like of the running carriage. Until the running carriage stops at the destination position, the slip control is repeated.

According to the embodiment, the following effects can be obtained.

### (1) It is possible to detect the amount of slip occurring per time.

### (2) As a result, it is possible to carry out feedback control of the running motors to eliminate the slip.

### (3) Because the slip can be detected independently in the front and rear running wheels, it is possible to appropriately control the running wheel which is slipping.

### (4) As a result, it is possible to suppress the delay of the running carriage from the running velocity pattern, and the running carriage can accurately run to the destination in the predetermined running time and accurately stop at the destination.

(5) Because the running carriage can run following the running velocity pattern, the maximum acceleration needs not be restricted to suppress occurrence of the slip and the breaking distance needs not be increased so that the running carriage can stop at the destination even if the slip occurs.
(6) Because the running velocity pattern is generally determined to suppress vibration of the running carriage, it is possible to reduce vibration of the running carriage by reducing delay from the running velocity pattern.

What is claimed is:

1. A running carriage comprising:
means for obtaining an amount of driving of driving wheels of the running carriage and a change per time in the amount of driving;
means for obtaining an absolute position of the running carriage and a change per time in the absolute position;
detecting means for comparing the change in the amount of driving and the change in the absolute position to obtain an amount of slip per time of the running carriage; and
control means for controlling a driving motor of the driving wheels to eliminate the obtained amount of slip.

2. The running carriage according to claim 1, wherein the control means reduces a rotating speed of the driving motor when the change in the amount of driving is greater than the change in the absolute position by a value equal to or greater than a predetermined value, and increases the rotating speed of the driving motor when the change in the amount of driving is smaller than the change in the absolute position by a value equal to or greater than the predetermined value.

3. A method of controlling a running carriage, including the steps of:
obtaining an amount of driving of driving wheels of the running carriage and a change per time in the amount of driving;
obtaining an absolute position of the running carriage and a change per time in the absolute position;
comparing the change in the amount of driving and the change in the absolute position to obtain an amount of slip per time of the running carriage; and
controlling a driving motor of the driving wheels to eliminate the obtained amount of slip.

4. A running carriage system comprising marks provided in at least two lines while spaced from each other along a running route of a running carriage, the running carriage including:
means for obtaining an amount of driving of driving wheels of the running carriage and a change per time in the amount of driving;
at least two linear sensors for detecting the marks in at least two lines;
means for obtaining an absolute position of the running carriage and a change per time in the absolute position from outputs of the at least two linear sensors;
means for comparing the change in the amount of driving and the change in the absolute position to obtain an amount of slip per time of the running carriage; and
control means for controlling a driving motor of the driving wheels to eliminate the obtained amount of slip.
